(19) United States
(12) Patent Application Publication
(10) Pub. No.: US 2017/0316514 A1
(43) Pub. Date: Nov. 2, 2017

(54) JOB APPLICANT QUALITY MODEL

(71) Applicant: LinkedIn Corporation, Mountain View, CA (US)

(72) Inventors: Fangzi Huang, Santa Clara, CA (US); Monica Marie Lewis, Menlo Park, CA (US); Songtao Guo, Cupertino, CA (US); Vibhu Prakash Saxena, Milpitas, CA (US); Aaron Tyler Rucker, San Francisco, CA (US)

(21) Appl. No.: 15/140,312

(22) Filed: Apr. 27, 2016

(51) Int. Cl. G06Q 50/00; H04L 29/08; G06N 5/04

(52) U.S. Cl. CPC G06Q 50/01; G06N 5/046; H04L 67/02

(57) ABSTRACT

A system, a machine-readable storage medium storing instructions, and a computer-implemented method are described herein for Candidate Predictor Engine (“C.P. Engine”) instantiates data structure(s) modeled according to a plurality of job candidate predictor decision trees. The C.P. Engine encodes data representing a job candidate context feature set based on an attribute(s) of a target candidate account and an attribute(s) of a job posting. The C.P. Engine filters each respective feature from the job candidate context feature set through a job candidate predictor decision tree that corresponds to a same job candidate context feature type as the respective feature. The C.P. Engine generates prediction output based on each result of filtering through the job candidate predictor decision trees. The prediction output indicates a likelihood of the target candidate account being qualified for the job posting.

### TECHNICAL FIELD

The present disclosure generally relates to data processing systems. More specifically, the present disclosure relates to methods, systems and computer program products for inferring relevance between a member account(s) and a job posting(s).

### BACKGROUND

A social networking service is a computer- or web-based application that enables users to establish links or connections with persons for the purpose of sharing information with one another. Some social networking services aim to enable friends and family to communicate with one another, while others are specifically directed to business users with a goal of enabling the sharing of business information. For purposes of the present disclosure, the terms “social network” and “social networking service” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks”).

With many social networking services, members are prompted to provide a variety of personal information, which may be displayed in a member's personal web page. Such information is commonly referred to as personal profile information, or simply “profile information”, and when shown collectively, it is commonly referred to as a member's profile. For example, with some of the many social networking services in use today, the personal information that is commonly requested and displayed includes a member's age, gender, interests, contact information, home town, address, the name of the member's spouse and/or family members, and so forth. With certain social networking services, such as some business networking services, a member's personal information may include information commonly included in a professional resume or curriculum vitae, such as information about a person's education, employment history, skills, professional organizations, and so on. With some social networking services, a member's profile may be viewable to the public by default, or alternatively, the member may specify that only some portion of the profile is to be public by default. Accordingly, many social networking services serve as a sort of directory of people to be searched and browsed.

### DESCRIPTION OF THE DRAWINGS

Some embodiments are illustrated by way of example and not limitation in the figures of the accompanying drawings in which:

FIG. 1 is a block diagram showing the functional components of a social networking service, according to various embodiments of the invention;

FIG. 2 is a block diagram of an example system, according to various embodiments;

FIG. 3 is a flowchart illustrating an example method, according to various embodiments;

FIG. 4 illustrates a schematic diagram of an exemplary data flow in Candidate Predictor Engine, according to various embodiments;

FIG. 5 illustrates a block diagram of a job candidate predictor decision tree for a matching skills feature, according to various embodiments;

FIG. 6 illustrates a block diagram of a job candidate predictor decision tree for a job industry feature, according to various embodiments;

FIG. 7 is a flowchart illustrating an example method for determining a years difference value as a comparison feature in a job-to-candidate feature subset, according to various embodiments;

FIG. 8 is a block diagram showing example components of a Candidate Predictor Engine, according to some embodiments;

FIG. 9 is a diagrammatic representation of a machine in the example form of a computer system within which a set of instructions, for causing the machine to perform any one or more of the methodologies discussed herein, may be executed according to various embodiments.

### DETAILED DESCRIPTION

The present disclosure describes methods and systems for predicting a relevance of one or more target candidate accounts and one or more job postings. In the following description, for purposes of explanation, numerous specific details are set forth in order to provide a thorough understanding of the various aspects of different embodiments of the present invention. It will be evident, however, to one skilled in the art, that the present invention may be practiced without all of the specific details.

A system, a machine-readable storage medium storing instructions, and a computer-implemented method are described herein for a Candidate Predictor Engine (“C.P. Engine”) that instantiates data structure(s) modeled according to a plurality of job candidate predictor decision trees. The C.P. Engine encodes data representing a job candidate context feature set based on an attribute(s) of a target candidate account and an attribute(s) of a job posting. The C.P. Engine filters each respective feature from the job candidate context feature set through a job candidate predictor decision tree that corresponds to a same job candidate context feature type as the respective feature. The C.P. Engine generates prediction output based on each result of filtering through the job candidate predictor decision trees. The prediction output indicates a likelihood of the target candidate account being qualified for the job posting.

In example embodiments, the C.P. Engine utilizes a prediction model for predicting whether a given target candidate account in a professional social network service is relevant to a current job posting submitted by an employer account in the professional social network service. Stated differently, the C.P. Engine builds a job applicant quality model to infer whether the attributes of a given job candidate account indicate that the given job candidate account is relevant to the attributes of a job posting submitted by an employer account. Upon inferring that a target candidate account is relevant to a job posting, the C.P. Engine tags the target candidate account as a “quality job applicant.” The C.P. Engine thereby assists the employer account in identifying the best (or most qualified) potential job applicants for the current job posting without having to manually review only those social network member accounts who actually apply to the current job posting.

The C.P. Engine may use various prediction modeling techniques to generate the job applicant quality model. For example, according to various exemplary embodiments, the C.P. Engine builds a plurality of job candidate predictor decision trees according to a random forest algorithm. The C.P. Engine implements the random forest algorithm over logged interaction data from the professional social network service in order to learn a branch label for each branch of each job candidate predictor decision tree. Each candidate predictor decision tree corresponds to a pre-defined feature of a job candidate context feature set. For example, a first candidate predictor decision tree corresponds to a first type of feature in the job candidate context feature set and a second candidate predictor decision tree corresponds to a second type of feature in the job candidate context feature set.

The C.P. Engine calculates a percentage of all decision tree results that indicate whether the target candidate account is acceptable. If the percentage meets a threshold percentage, the C.P. Engine infers the target candidate account is qualified for the job posting.

It is understood that various embodiments further include encoded instructions that comprise operations to generate a user interface(s) and various user interface elements. The user interface and the various user interface elements can be representative of any of the operations, data, decision trees, prediction output, features, accounts and job postings, as described herein. In addition, the user interface and various user interface elements are generated by the C.P. Engine for display on a computing device, a server computing device, a mobile computing device, etc.

According to various exemplary embodiments, the C.P. Engine may be used for the purposes of both off-line training (for generating, training, and refining the job applicant quality model and online inferences (for predicting whether a given job candidate account is relevant to a given job posting).

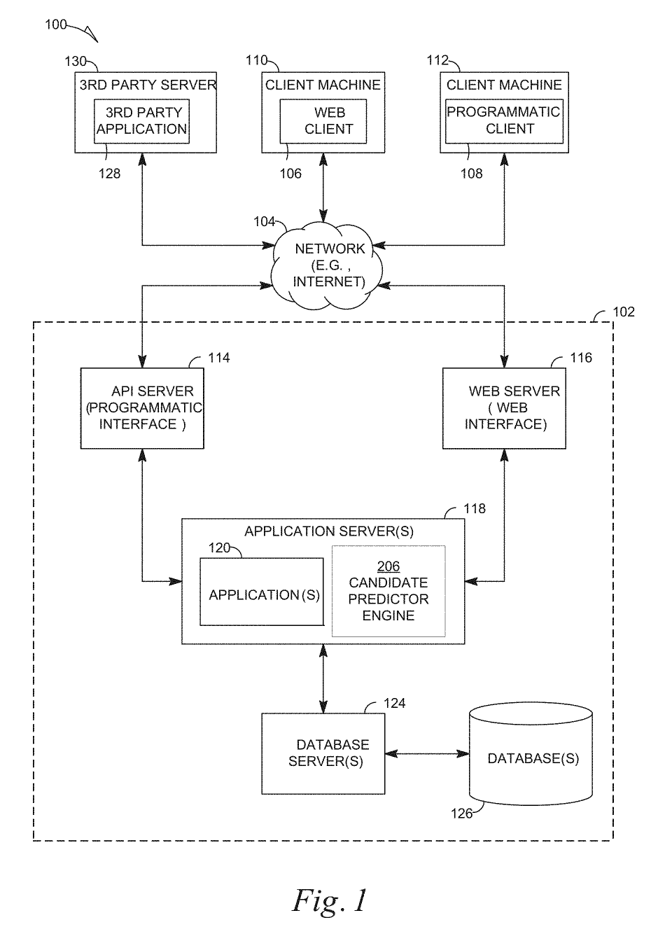

Turning now to FIG. 1, FIG. 1 is a block diagram illustrating a client-server system, in accordance with an example embodiment. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102. In some embodiments, the application servers 118 include candidate predictor engine 206. However, it is understood that the candidate predictor engine 206 can be implemented by any component(s) of system 102. It is also understood a portion of the candidate predictor engine 206 can be implemented by any component(s) of system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102. In some embodiments, the networked system 102 may comprise functional components of a professional social network.

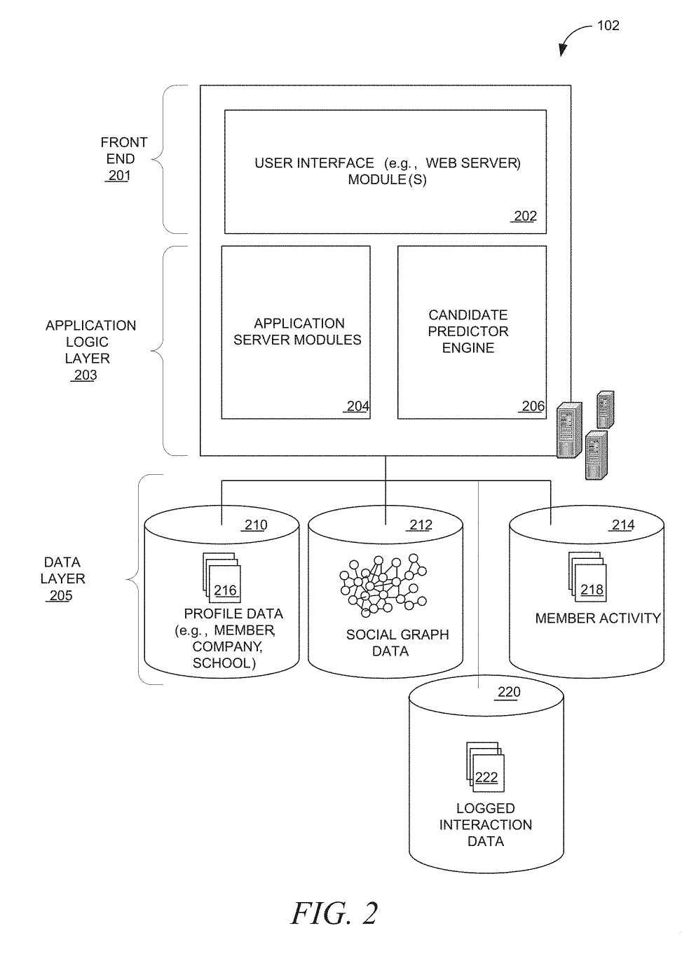

FIG. 2 is a block diagram showing functional components of a professional social network within the networked system 102, in accordance with an example embodiment.

As shown in FIG. 2, the professional social network may be based on a three-tiered architecture, consisting of a front-end layer 201, an application logic layer 203, and a data layer 205. In some embodiments, the modules, systems, and/or Systems shown in FIG. 2 represent a set of executable software instructions and the corresponding hardware (e.g., memory and processor) for executing the instructions. To avoid obscuring the inventive subject matter with unnecessary detail, various functional modules and systems that are not germane to conveying an understanding of the inventive subject matter have been omitted from FIG. 2. However, one skilled in the art will readily recognize that various additional functional modules and systems may be used with a professional social network, such as that illustrated in FIG. 2, to facilitate additional functionality that is not specifically described herein. Furthermore, the various functional modules and systems depicted in FIG. 2 may reside on a single server computer, or may be distributed across several server computers in various arrangements. Moreover, although a professional social network is depicted in FIG. 2 as a three-tiered architecture, the inventive subject matter is by no means limited to such architecture. It is contemplated that other types of architecture are within the scope of the present disclosure.

As shown in FIG. 2, in some embodiments, the front-end layer 201 comprises a user interface module (e.g., a web server) 202, which receives requests and inputs from various client-computing devices, and communicates appropriate responses to the requesting client devices. For example, the user interface module(s) 202 may receive requests in the form of Hypertext Transport Protocol (HTTP) requests, or other web-based, application programming interface (API) requests.

In some embodiments, the application logic layer 203 includes various application server modules 204, which, in conjunction with the user interface module(s) 202, generates various user interfaces (e.g., web pages) with data retrieved from various data sources in the data layer 205. In some embodiments, individual application server modules 204 are used to implement the functionality associated with various services and features of the professional social network. For instance, the ability of an organization to establish a presence in a social graph of the social network service, including the ability to establish a customized web page on behalf of an organization, and to publish messages or status updates on behalf of an organization, may be services implemented in independent application server modules 204. Similarly, a variety of other applications or services that are made available to members of the social network service may be embodied in their own application server modules 204.

As shown in FIG. 2, the data layer 205 may include several databases, such as a database 210 for storing profile data 216, including both member profile attribute data as well as profile attribute data for various organizations. Consistent with some embodiments, when a person initially registers to become a member of the professional social network, the person will be prompted to provide some profile attribute data such as, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information may be stored, for example, in the database 210. Similarly, when a representative of an organization initially registers the organization with the professional social network the representative may be prompted to provide certain information about the organization. This information may be stored, for example, in the database 210, or another database (not shown). With some embodiments, the profile data 216 may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or a seniority level within a particular company. With some embodiments, importing or otherwise accessing data from one or more externally hosted data sources may enhance profile data 216 for both members and organizations. For instance, with companies in particular, financial data may be imported from one or more external data sources, and made part of a company's profile.

The profile data 216 may also include information regarding settings for members of the professional social network. These settings may comprise various categories, including, but not limited to, privacy and communications. Each category may have its own set of settings that a member may control.

Once registered, a member may invite other members, or be invited by other members, to connect via the professional social network. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates or other messages published by the member being followed, or relating to various activities undertaken by the member being followed. Similarly, when a member follows an organization, the member becomes allowed to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, may be stored and maintained as social graph data within a social graph database 212.

The professional social network may provide a broad range of other applications and services that allow members the opportunity to share and receive information, often customized to the interests of the member. For example, with some embodiments, the professional social network may include a photo sharing application that allows members to upload and share photos with other members. With some embodiments, members may be able to self-organize into groups, or interest groups, organized around a subject matter or topic of interest. With some embodiments, the professional social network may host various job listings providing details of job openings with various organizations.

As members interact with the various applications, services and content made available via the professional social network, the members' behaviour (e.g., content viewed, links or member-interest buttons selected, etc.) may be monitored and information 218 concerning the member's activities and behaviour may be stored, for example, as indicated in FIG. 2, by the database 214. This information 218 can be training data that comprises in part professional social network activity of member accounts and employer account's with respect to one or more job postings. Such professional social network activity includes a member account viewing a job posting(s), an employer account viewing a profile of a member account that is a target candidate account, a member account applying to a job posting, an employer account selecting a member account that applied to a job posting for hire, an employer account not selecting a member account that applied to a job posting for hire. The data layer 205 further includes a logged interaction data repository 220, which includes previous determinations 222 of whether given member accounts are qualified for respective job postings.

In some embodiments, the professional social network provides an application programming interface (API) module via which third-party applications can access various services and data provided by the professional social network. For example, using an API, a third-party application may provide a user interface and logic that enables an authorized representative of an organization to publish messages from a third-party application to a content hosting platform of the professional social network that facilitates presentation of activity or content streams maintained and presented by the professional social network. Such third-party applications may be browser-based applications, or may be operating system-specific. In particular, some third-party applications may reside and execute on one or more mobile devices (e.g., a smartphone, or tablet computing devices) having a mobile operating system.

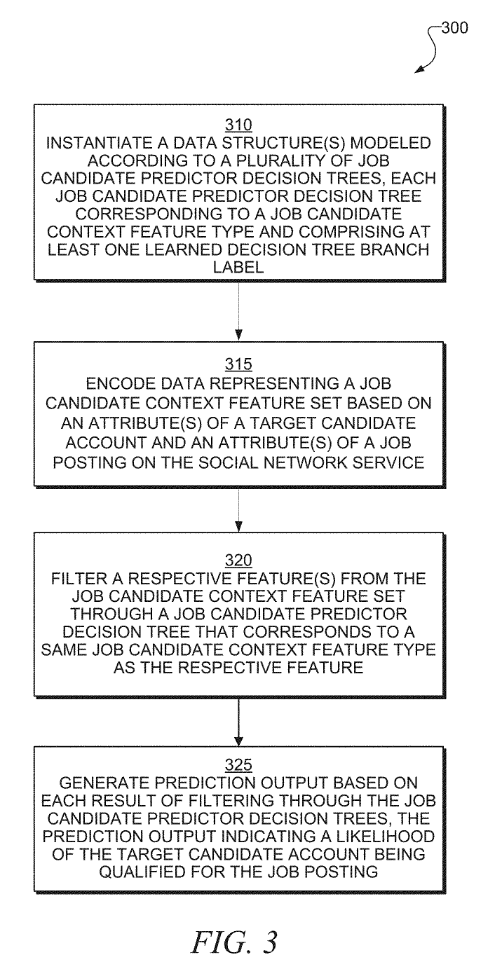

The data in the data layer 205 may be accessed, used, and adjusted by the C.P. Engine 206 as will be described in more detail below in conjunction with FIGS. 3-8. Although the C.P. Engine 206 is referred to herein as being used in the context of a professional social network, it is contemplated that it may also be employed in the context of any website or online services, including, but not limited to, content sharing sites (e.g., photo- or video-sharing sites) and any other online services that allow users to have a profile and present themselves or content to other users. Additionally, although features of the present disclosure are referred to herein as being used or presented in the context of a web page, it is contemplated that any user interface view (e.g., a user interface on a mobile device or on desktop software) is within the scope of the present disclosure. It is understood that the C.P. Engine 206 can be implemented in one or more of the application servers 118.

FIG. 3 is a flowchart illustrating an example method 300, according to various embodiments.

At operation 310, the C.P. Engine 206 instantiates a data structure(s) modeled according to a plurality of job candidate predictor decision trees. Each job candidate predictor decision tree corresponds to a job candidate context feature type and comprises at least one learned decision tree branch label. For example, a first candidate predictor decision tree corresponds to a candidate account's job function feature and a second candidate predictor decision tree corresponds to a skill match count between a job candidate account's skills and a job posting's skills. It is understood that a respective candidate predictor decision tree can correspond to any type of feature, such as a job industry feature or a job company size feature.

At operation 315, the C.P. Engine 206 encodes data representing a job candidate context feature set based on at least one attribute of a target candidate account of a social network service and at least one attribute of a job posting on the social network service. The C.P. Engine 206 encodes a job candidate feature data subset based on an attribute(s) of the target candidate account that corresponds with at least one pre-defined type of candidate feature that is predictive of whether a given job candidate is qualified for a given job posting. For example, a candidate feature can be a job function. The C.P. Engine 206 accesses one or more job function attributes from the target candidate account and encodes those attributes as candidate job function features.

The C.P. Engine 206 encodes a job feature data subset based on an attribute(s) of the job posting that corresponds with at least one pre-defined type of job feature that is predictive of whether the given job candidate is qualified for the given job posting. For example, a job feature can be a level of seniority required by the job posting. The C.P. Engine 206 accesses one or more seniority level attributes from the job posting and encodes those attributes as job seniority level features.

The C.P. Engine 206 encodes a candidate-to-job comparison feature data subset to include a difference value between attributes of the target candidate account and the job posting. The difference between the attributes corresponds with a pre-defined type of comparison feature that is predictive of whether the given job candidate is qualified for the given job posting. For example, a comparison feature can number of match skills between a given candidate account and a given job posting. The C.P. Engine 206 accesses one or more skills attributes from the target candidate account and the job posting and calculates a total amount of common skills attributes between the target candidate account and the job posting. The C.P. Engine 206 encodes a matching skills count feature as a comparison feature.

At operation 320, the C.P. Engine 206 filters respective feature(s) from the job candidate context feature set through a job candidate predictor decision tree that corresponds to a same job candidate context feature type as the respective feature.

The C.P. Engine 206 applies the first candidate predictor decision tree to the candidate account's job function feature. The first candidate predictor decision returns a result indicating whether the target candidate account is a qualified job applicant. The C.P. Engine 206 applies the second candidate predictor decision tree to the matching skills count feature. The second candidate predictor decision also returns a result indicating whether the target candidate account is a qualified job applicant.

At operation 325, the C.P. Engine 206 generates prediction output based on each result of filtering through the job candidate predictor decision trees. Each job candidate predictor decision tree returns a result indicating whether whether the target candidate account is a qualified job applicant. The C.P. Engine 206 calculates whether a threshold percentage of the tree results indicate that the target candidate account is a qualified job applicant. If the threshold percentage is satisfied, the C.P. Engine 206 generates prediction output indicating the target candidate account is a qualified job applicant

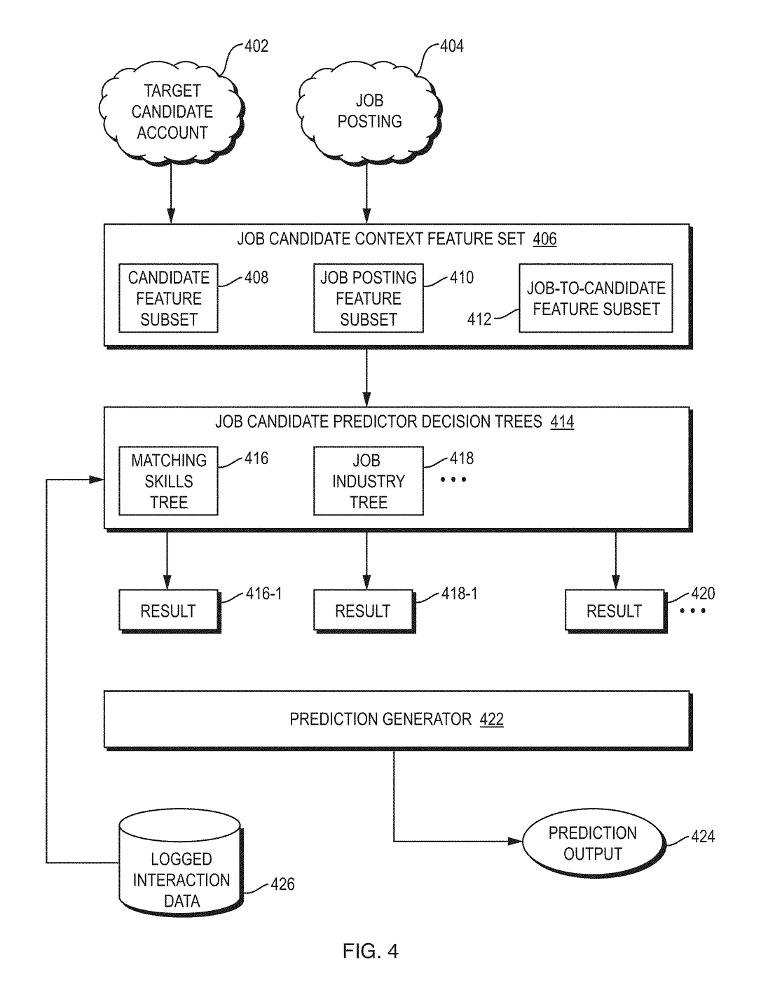

FIG. 4 illustrates a schematic diagram of an exemplary data flow in Candidate Predictor Engine 206, according to various embodiments.

As shown in FIG. 4, the C.P. Engine 206 creates a Job Candidate Feature Context Set 406 based on the attributes of a target candidate account 402 and attributes of a job posting 404. Such attributes includes, as non-limiting examples: education, job function, job industry, skills, years of professional experience, job title, job location, size of company, job seniority.

Each feature in the Job Candidate Feature Context Set 406 is pre-defined as being germane in predicting a relevance between a give candidate account and a given job posting. Such features can also be based on one or more of the following account attributes: education, job function, job industry, skills, years of professional experience, job title, job location, size of company, job seniority.

The candidate feature subset 408 includes those attribute types of the target candidate account 402 that have been pre-defined as features of the job applicant quality model implemented by the C.P. Engine 206. The job posting feature subset 410 includes those attributes types of the job posting 404 that have been pre-defined as features of the job applicant quality model.

In addition, particular differences between the attributes of the target candidate account 402 and the job posting 404 are also pre-defined as being germane in predicting a relevance between a given candidate account and a given job posting. For the job-to-candidate feature subset 412, the C.P. Engine 206 compares attributes between the target candidate account 402 and the job posting 404 to generate comparison features. For example, the C.P. Engine 206 compares the skills of the target candidate account 402 and the skills required by the job posting 404 to generate skills comparison features for the job-to-candidate feature subset 412. Such skills comparison features can be a percentage of matching skills and a total number of matching skills.

In another example, the C.P. Engine 206 compares the years of professional experience attribute of the target candidate account 402 and the years of professional experience attribute required by the job posting 404 to generate years of experience comparison feature for the job-to-candidate feature subset 412. Such a years of experience comparison feature can be a difference between the target candidate account's 402 years of professional experience and the years of professional experience required by the job posting 404.

The C.P. Engine 206 filters features from the candidate feature subset 408, the job feature subset 410 and the job-to-candidate feature subset 412 through a plurality of job candidate predictor decision trees 414. The C.P. Engine 206 builds the job candidate predictor decision tree 414 based on logged interaction data 426 and branch labels for the branches of each tree 416, 418 . . . are learned according to applying a random forest algorithm to the logged interaction data 426.

The logged interaction data 426 includes a plurality of previous determinations from respective employer accounts about whether various job candidate accounts are qualified for one or more job postings. The logged interaction data 426 is thereby used by the C.P. Engine 206 as training data in order to learn relationships between candidate features and job posting features that are indicative of whether a given candidate account will be qualified for a given job posting. The C.P. Engine 206 creates the plurality of tress 414 and learns branch labels for each branch of each tree 416, 418 . . . as a result of applying the random forest algorithm to the logged interaction data 426.

Each tree 416, 418 . . . corresponds to a particular feature in the job candidate context feature set 406. For example, the matching skills tree 416 has a root branch label that corresponds to a skills comparison feature from the job-to-candidate feature subset 412. Such a skills comparison feature can be the percentage of matching skills. According to another example, the job industry tree 418 has a root branch label that corresponds with an industry comparison feature from the job-to-candidate feature subset 412. Such an industry comparison feature can be a determination of whether the target candidate account 402 and the job posting 404 share a threshold amount of the same amount job industry descriptors between the target candidate account 402 and the job posting 404. It is understood that various trees can correspond to other features such as: job function, difference in years of experience, job country location, job company size, job seniority, current job industry, job region.

Each tree 416, 418 . . . produces a result 416-1, 418-1 . . . 420 . . . . Each result 416-1, 418-1 . . . 420 . . . is a positive determination (“1”) or negative determination (“0”) returned by the corresponding tree 416, 418 . . . . A prediction generator 422 of the C.P. Engine 206 receives all the results 416-1, 418-1 . . . 420 . . . from all the trees 416-1, 418-1 . . . 420 . . . and calculates whether at least a certain percentage of the results 416-1, 418-1 . . . 420 . . . are positive determinations (“1”). If a certain percentage of the results 416-1, 418-1 . . . 420 . . . are positive determinations (“1”), the prediction output 424 indicates the target candidate account 402 is qualified for the job posting 404. If a certain percentage of the results 416-1, 418-1 . . . 420 . . . are not positive determinations (“0”), the prediction output 424 indicates the target candidate account 402 is not qualified for the job posting 404.

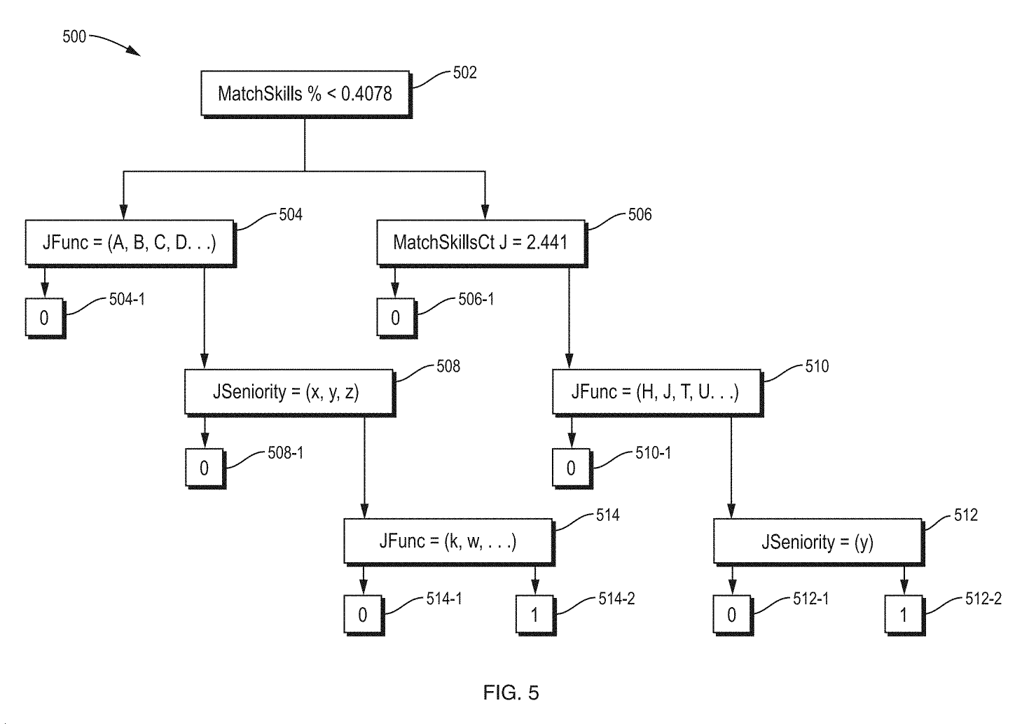

FIG. 5 illustrates a block diagram of a job candidate predictor decision tree 500 for a matching skills feature, according to various embodiments.

The job candidate predictor decision tree 500 of FIG. 5 represents the matching skills tree 416 in FIG. 4. The matching skills tree 416 has one or more branch labels 502, 504, 506, 508, 510, 512, 514 that are learned by using the logged interaction data 426 as training data for a random forest algorithm. The matching skills tree 416 corresponds to a skills comparison feature, such as percentage of matching skills.

The C.P. Engine 206 accesses a skills comparison feature, such as the percentage of matching skills between the target candidate account 402 and the job posting 404, from the job-to-candidate feature subset 412. The root branch label 502 requires a learned matching skills threshold of just under 41% (40.78%). If the skills comparison feature indicates that the percentage of matching skills between the target candidate account 402 and the job posting 404 is less than 40.78%, the C.P. Engine 206 accesses branch label 504.

Branch label 504 requires the job posting 404 should list (or relate to) one or more job functions (A, B, C, D . . . ). The job functions listed at branch label 504 are learned from the logged interaction data 426. If the job posting 404 does not list (or relate to) any of the job functions (A, B, C, D . . . ) required at branch label 504, the matching skills tree 416 returns a negative determination 504-1 indicating the target candidate account 402 is not qualified. If the job posting 404 does list (or relate to) any of the job functions (A, B, C, D . . . ) required at branch label 504, the C.P. Engine 206 accesses branch label 508.

Branch label 508 requires the job posting 404 should list (or relate to) one or more levels of professional seniority (x, y, z). If the job posting 404 does not list (or relate to) one or more levels of professional seniority (x, y, z), the matching skills tree 416 returns a negative determination 508-1 indicating the target candidate account 402 is not qualified. If the job posting 404 does list (or relate to) one or more levels of professional seniority (x, y, z), the C.P. Engine 206 accesses branch label 514.

Branch label 514 requires the job posting 404 should list (or relate to) one or more different job functions (k, w . . . ) than those required at branch label 504. The job functions listed at branch label 514 are learned from the logged interaction data 426. If the job posting 404 does not list (or relate to) any of the job functions (k, w . . . ) required at branch label 514, the matching skills tree 416 returns a negative determination 514-1 indicating the target candidate account 402 is not qualified. If the job posting 404 does list (or relate to) any of the job functions (k, w . . . ) required at branch label 514, the matching skills tree 416 returns a positive determination 514-2 indicating the target candidate account 402 is qualified.

Returning to branch label 502, if the percentage of matching skills is greater than 40.78%, the C.P. Engine 206 accesses branch label 506. Branch label 506 includes a learned matching skills count between a candidate account and a job posting. The learned matching skills count is 2.441. If the number of matching skills between the target candidate account 402 and the job posting 404 is less than 2.441, the matching skills tree 416 returns a negative determination 506-1 indicating the target candidate account 402 is not qualified.

If the number of matching skills between the target candidate account 402 and the job posting 404 is greater than 2.441, the C.P. Engine 206 accesses branch label 510. Branch label 510 requires the job posting 404 should list (or relate to) one or more job functions (H, J, T, U . . . ). The job functions listed at branch label 510 are learned from the logged interaction data 426. If the job posting 404 does not list (or relate to) any of the job functions (H, J, T, U . . . ) required at branch label 510, the matching skills tree 416 returns a negative determination 510-1 indicating the target candidate account 402 is not qualified. If the job posting 404 does list (or relate to) any of the job functions (H, J, T, U . . . ) required at branch label 510, the C.P. Engine 206 accesses branch label 512.

Branch label 508 requires the job posting 404 should list (or relate to) one or more levels of professional seniority (x, y, z). If the job posting 404 does not list (or relate to) one or more levels of professional seniority (x, y, z), the matching skills tree 416 returns a negative determination 508-1 indicating the target candidate account 402 is not qualified. If the job posting 404 does list (or relate to) one or more levels of professional seniority (x, y, z), the C.P. Engine 206 accesses branch label 514.

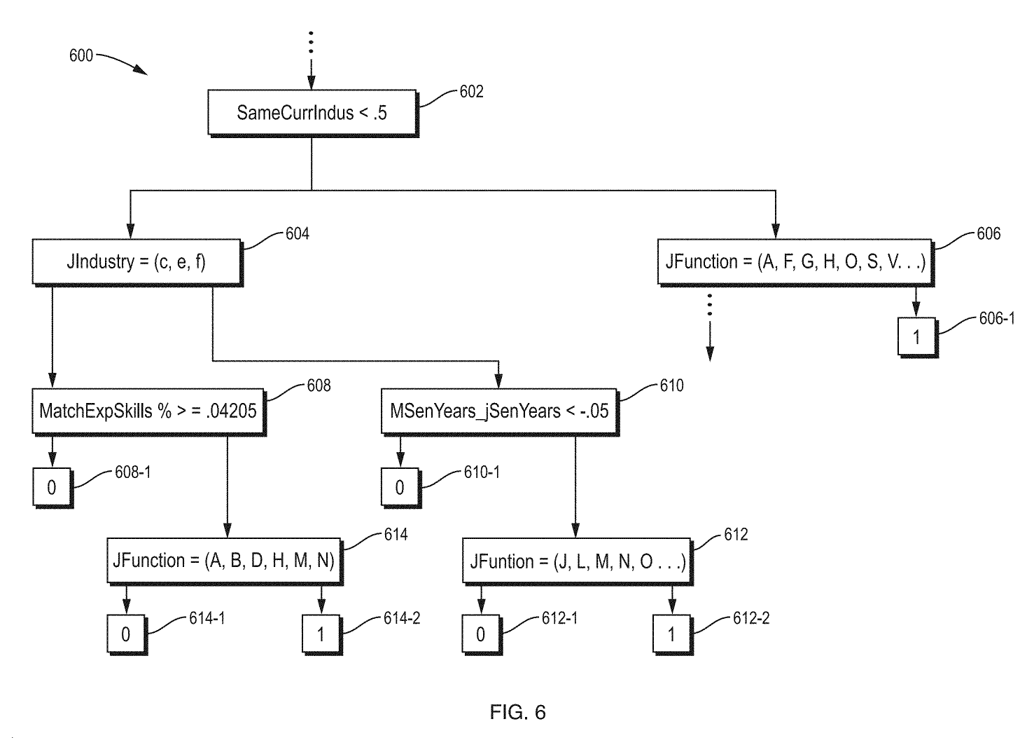

FIG. 6 illustrates a block diagram of a job candidate predictor decision tree 600 for a job industry feature, according to various embodiments.

The job candidate predictor decision tree 600 of FIG. 6 represents a portion of the job industry tree 418 in FIG. 4. The job industry tree 418 has one or more branch labels 602, 604, 606, 608, 610, 612, 614 that are learned by using the logged interaction data 426 as training data for a random forest algorithm. The job industry tree 418 corresponds to a current industry comparison feature from the job-to-candidate feature subset 412.

The C.P. Engine 206 accesses branch label 602 and determines whether job industry feature in the candidate feature set 408 is not the same as the job industry feature in the job posting feature set 408. If the job features are the same, the C.P. Engine 206 accesses branch label 604. Branch label 604 requires the job posting 404 should list (or relate to) one or more job industries (c, e, f). The job industries listed at branch label 604 are learned from the logged interaction data 426. If the job posting 404 does not list (or relate to) any of the job industries (c, e, f) required at branch label 604, the C.P. Engine 206 accesses branch label 608.

Branch label 608 requires a learned matching skills threshold of greater than or equal to 4.2%. If the skills comparison feature indicates that the percentage of matching skills between the target candidate account 402 and the job posting 404 is less than 4.2%, the job industry tree 418 returns a negative determination 504-1 indicating the target candidate account 402 is not qualified. If the skills comparison feature indicates that the percentage of matching skills between the target candidate account 402 and the job posting 404 is greater than or equal to 4.2%, the C.P. Engine 206 accesses branch label 614.

Branch label 614 requires the job posting 404 should list (or relate to) one or more different job functions (A, B, D, H, M, N). The job functions listed at branch label 614 are learned from the logged interaction data 426. If the job posting 404 does not list (or relate to) any of the job functions (A, B, D, H, M, N) required at branch label 614, the job industry tree 418 returns a negative determination 614-1 indicating the target candidate account 402 is not qualified. If the job posting 404 does list (or relate to) any of the job functions (A, B, D, H, M, N) required at branch label 614, the job industry tree 418 returns a positive determination 614-2 indicating the target candidate account 402 is qualified.

Returning to branch label 604, if the job posting 404 does list (or relate to) any of the job industries (c, e, f) required at branch label 604, the C.P. Engine 206 accesses branch label 610. Branch label 610 requires the use of a comparison feature from the job-to-candidate feature subset 412 that represents a difference in years of professional experience between the target candidate account 402 and the job posting 404. Branch label 610 represents a requirement that target candidate account's 402 years of professional experience be less than the years of professional experience required by the job posting 404 minus 0.5 years (i.e. job posting required years of professional experience −0.5). If the requirement of branch label 610 is not satisfied, the job industry tree 418 returns a negative determination 610-1 indicating the target candidate account 402 is not qualified. If the requirement of branch label 610 is satisfied, the C.P. Engine 206 accesses branch label 612.

Branch label 612 requires the job posting 404 should list (or relate to) one or more job functions (J, L, M, N, O . . . ). The job functions listed at branch label 612 are learned from the logged interaction data 426. If the job posting 404 does not list (or relate to) any of the job functions (J, L, M, N, O . . . ). required at branch label 612, the job industry tree 418 returns a negative determination 612-1 indicating the target candidate account 402 is not qualified. If the job posting 404 does list (or relate to) any of the job functions (J, L, M, N, O . . . ). required at branch label 612, the job industry tree 418 returns a positive determination 612-3 indicating the target candidate account 402 is qualified.

Returning to branch label 602, if the job features are not the same, the C.P. Engine 206 accesses branch label 606. Branch label 606 requires the job posting 404 should list (or relate to) one or more job functions (A, F, G, H, O, S, V . . . ). The job functions listed at branch label 606 are learned from the logged interaction data 426. If the job posting 404 does list (or relate to) any of the job functions (A, F, G, H, O, S, V . . . ), the job industry tree 418 returns a positive determination 606-1 indicating the target candidate account 402 is qualified.

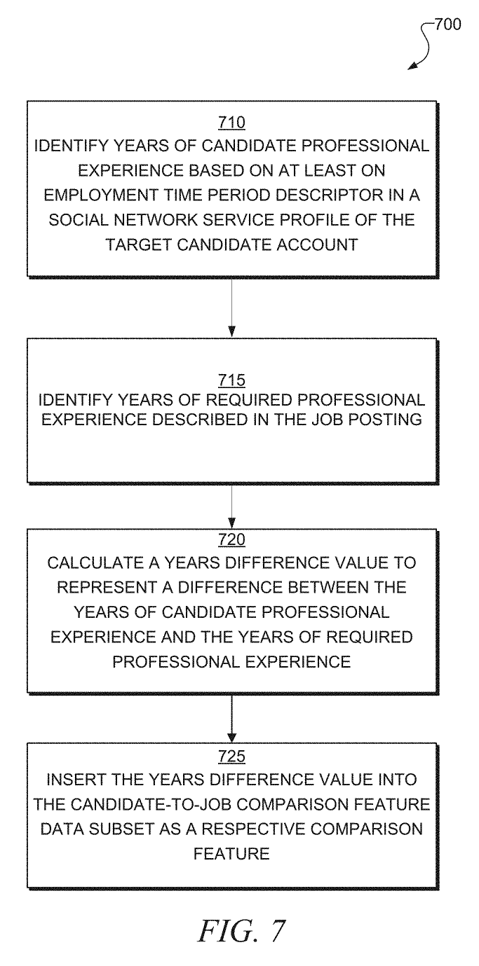

FIG. 7 is a flowchart illustrating an example method 700 for determining a years difference value as a comparison feature in a job-to-candidate feature subset, according to various embodiments.

As shown in FIG. 4, the C.P. Engine 206 generates subsets 408, 410, 412 of features for the job candidate context feature set 406. The subsets 408, 410, 412 of features are based on attributes of the target candidate account 402 and the job posting 404. A feature is an attribute, attribute value, or relationship between attributes, that is pre-defined in the job applicant quality model as being germane in predicting whether a given candidate account is qualified for a given job posting.

The job-to-candidate feature subset 412 includes comparison features. A comparison feature can be, for example, a value generated via a comparison of the target candidate account's years of professional experience and the years of professional experience required by the job posting 404.

At operation 710, the C.P. Engine 206 identifies years of candidate professional experience based at least on employment time period descriptor in a social network service profile of the target candidate account. For example, the C.P. Engine 206 accesses a data location(s) in the social network service representative of the attribute(s) of the target candidate account 402. The C.P. Engine 206 identifies a descriptor(s) in the accessed data location(s) that corresponds with years of professional experience of the target candidate account 402. The C.P. Engine 206 obtains a first value of the years of candidate's professional experience from the accessed data location(s).

At operation 715, the C.P. Engine 206 identifies years of required professional experience described in the job posting. For example, the C.P. Engine 206 accesses a data location(s) in the social network service representative of the attribute(s) of the job posting 404. The C.P. Engine 206 identifies a descriptor(s) in the accessed data location(s) that corresponds with years of professional experience of required by the job posting 404. The C.P. Engine 206 obtains a second value of the years of professional experience required by the job posting 404 from the accessed data location(s).

At operation 720, the C.P. Engine 206 calculates a years difference value to represent a difference between the years of candidate professional experience and the years of required professional experience. For example, the C.P. Engine 206 calculates a difference between the first value and the second value to generated a years difference value.

At operation 725, the C.P. Engine 206 inserts the years difference value into the candidate-to-job comparison feature data subset as a respective comparison feature. For example, the C.P. Engine 206 identifies a data location(s) for a first comparison feature representative of a difference in years of professional experience. The C.P. Engine 206 inserts the calculated years difference value in the data location(s) for the first comparison feature.

In another embodiment, the C.P. Engine 206 identifies each skill descriptor in a social network service profile of the target candidate account. For example, the C.P. Engine 206 accesses a data location(s) in the social network service representative of the attribute(s) of the target candidate account 402. The C.P. Engine 206 identifies a descriptor(s) in the accessed data location(s) that corresponds with a candidate skill(s) of the target candidate account 402.

The C.P. Engine 206 identifies each skill descriptor described in the job posting. For example, the C.P. Engine 206 accesses a data location(s) in the social network service representative of the attribute(s) of the job posting 404. The C.P. Engine 206 identifies a descriptor(s) in the accessed data location(s) that corresponds with a job skill(s) required by the job posting 404.

The C.P. Engine 206 calculates a skill match value to represent a percentage of matching skill descriptors between the target candidate account's skill descriptors and each job posting's skill descriptors. For example, the C.P. Engine 206 identifies one or more matching skills between the candidate skill(s) and the job skill(s). The C.P. Engine 206 inserts the skill match value into the candidate-to-job comparison feature data subset as a respective comparison feature.

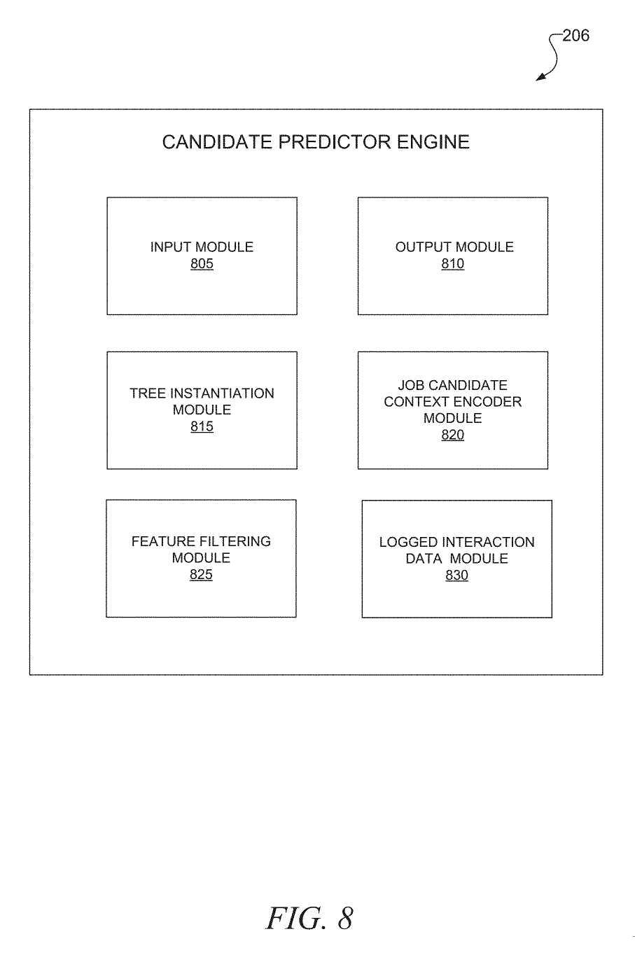

FIG. 8 is a block diagram showing example components of a Candidate Predictor Engine 206, according to some embodiments. As shown in FIG. 8, the C.P. Engine 206 includes an input module 805, output module 810, tree instantiation module 815, job candidate context encoder module 820, feature filtering module 825 and logged interaction data module 830.

The input module 805 is a hardware-implemented module that controls, manages and stores information related to any inputs from one or more components of system 102 as illustrated in FIG. 1 and FIG. 2. In various embodiments, the inputs include an attribute(s) of a member account(s) and an attribute(s) of a job posting(s). Inputs can also include logged interaction data comprising previous determinations of whether a candidate member account is or is not qualified for a particular job posting.

The output module 810 is a hardware-implemented module that controls, manages and stores information related to which sends any outputs to one or more components of system 102 as illustrated in FIG. 1 and FIG. 2. In some embodiments, the output is prediction output representing an inference of whether a target candidate account is qualified for a particular job posting. The prediction output is based on each result returned from each job candidate predictor decision tree.

The tree instantiation module 815 is a hardware implemented module which manages, controls, stores, and accesses information related to building one or more job candidate predictor decision trees. The tree instantiation module 815 builds a job candidate predictor decision tree for each type of feature in a job candidate context feature set. Each branch of each job candidate predictor decision tree comprises a label learned from executing a random forest algorithm with training data. The training data is based on the logged interaction data comprising previous determinations of whether a candidate member account is or is not qualified for a particular job posting.

The job candidate context encoder module 820 is a hardware-implemented module which manages, controls, stores, and accesses information related to encoding a job candidate context feature set. The job candidate context encoder module 820 accesses attributes of a target candidate account and a job posting in order to encode the job candidate context feature set. The job candidate context feature set includes features based on the attributes of a target candidate account and a job posting. Each feature is pre-defined and germane to predicting whether a given candidate account is relevant to a given job posting.

The feature filtering module 825 is a hardware-implemented module which manages, controls, stores, and accesses information related to filtering a feature from the job candidate context feature set through a particular job candidate predictor decision trees. Each job candidate predictor decision tree corresponds to a type of feature in the job candidate context feature set. The feature filtering module 825 filters each type of feature in the job candidate context feature set through the job candidate predictor decision tree that corresponds to the same type of feature. Each job candidate predictor decision tree returns either a positive determination or a negative determination of whether the target candidate account is a qualified applicant.

The logged interaction data module 830 is a hardware-implemented module which manages, controls, stores, and accesses information related to generating, updating and storing training data. The logged interaction data module 830 collects and store explicit determinations of whether a candidate member account is or is not qualified for a particular job posting. Each determination is received from an employer account that has submitted a job posting. Each determination represents the employer account's actual decision of whether the attributes of a member account are relevant to a given job posting. The logged interaction data module 830 includes the attributes of the member account, the attributes of the given job posting and the employer account's determination of whether or not the member account is qualified.

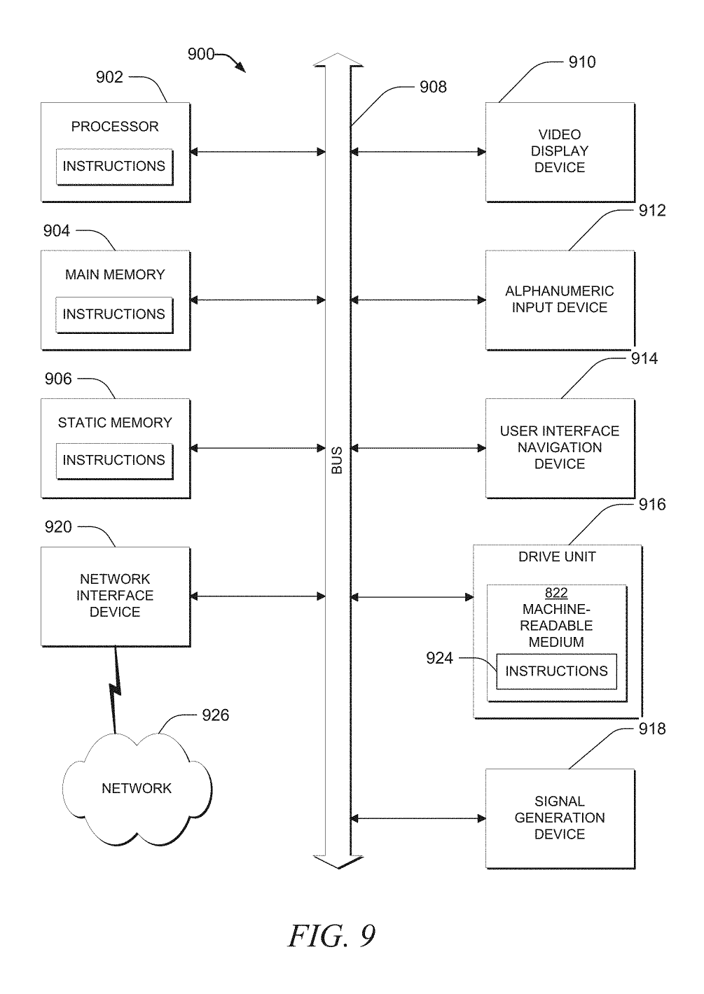

FIG. 9 is a diagrammatic representation of a machine in the example form of a computer system within which a set of instructions, for causing the machine to perform any one or more of the methodologies discussed herein, may be executed.

In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 900 includes a processor 902 (e.g., a central processing unit (CPU), a graphics processing unit (GPU) or both), a main memory 904, and a static memory 906, which communicate with each other via a bus 908. Computer system 900 may further include a video display device 910 (e.g., a liquid crystal display (LCD) or a cathode ray tube (CRT)). Computer system 900 also includes an alphanumeric input device 912 (e.g., a keyboard), a user interface (UI) navigation device 914 (e.g., a mouse or touch sensitive display), a disk drive unit 916, a signal generation device 918 (e.g., a speaker) and a network interface device 920.

Disk drive unit 916 includes a machine-readable medium 922 on which is stored one or more sets of instructions and data structures (e.g., software) 924 embodying or utilized by any one or more of the methodologies or functions described herein. Instructions 924 may also reside, completely or at least partially, within main memory 904, within static memory 906, and/or within processor 902 during execution thereof by computer system 900, main memory 904 and processor 902 also constituting machine-readable media.

While machine-readable medium 922 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present technology, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

Instructions 924 may further be transmitted or received over a communications network 926 using a transmission medium. Instructions 924 may be transmitted using network interface device 920 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the technology. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer system, comprising:
a processor;
a memory device holding an instruction set executable on the processor to cause the computer system to perform operations comprising:
instantiating at least one data structure modeled according to a plurality of job candidate predictor decision trees, each job candidate predictor decision tree corresponding to a job candidate context feature type and comprising at least one learned decision tree branch label;
encoding data representing a job candidate context feature set based on at least one attribute of a target candidate account of a social network service and at least one attribute of a job posting on the social network service;
filtering at least one respective feature from the job candidate context feature set through a job candidate predictor decision tree that corresponds to a same job candidate context feature type as the respective feature; and
generating prediction output based on each result of filtering through the job candidate predictor decision trees, the prediction output indicating a likelihood of the target candidate account being qualified for the job posting.

2. The computer system of claim 1, wherein encoding data representing a job candidate context feature set based on at least one attribute of the target candidate account of a social network service and at least one attribute of a job posting on the social network service comprises:
encoding a job candidate feature data subset to include the at least one attribute of the target candidate account that corresponds with at least one pre-defined type of candidate feature that is learned as being predictive of whether a given job candidate is qualified for a given job posting;
encoding a job feature data subset to include the at least one attribute of the job posting that corresponds with at least one pre-defined type of job feature that is learned as being predictive of whether the given job candidate is qualified for the given job posting; and
encoding a candidate-to-job comparison feature data subset to include a difference value between the at least one attribute of the target candidate account and the at least one attribute of the job posting that corresponds with a pre-defined type of comparison feature that is learned as being predictive of whether the given job candidate is qualified for the given job posting.

3. The computer system of claim 2, wherein the at least one pre-defined type of candidate feature comprises at least one of: a job function descriptor represented in a social network service profile of the target candidate account, a job industry descriptor represented in the social network service profile of the target candidate account, a job company size descriptor represented in the social network service profile of the target candidate account.

4. The computer system of claim 2, wherein the at least one pre-defined type of job feature comprises at least one of: a job function descriptor represented the job posting, a job industry descriptor represented in the job posting, a job company size descriptor represented in the job posting.

5. The computer system of claim 2, wherein encoding a candidate-to-job comparison feature data subset to include a difference value that corresponds with a pre-defined type of comparison feature that is learned as being predictive of whether a given job candidate is qualified for a given job posting comprises:
identifying years of candidate professional experience based on at least on employment time period descriptor in a social network service profile of the target candidate account;
identifying years of required professional experience described in the job posting;
calculating a years difference value to represent a difference between the years of candidate professional experience and the years of required professional experience; and
inserting the years difference value into the candidate-to-job comparison feature data subset as a respective comparison feature.

6. The computer system of claim 5, wherein inserting the years difference value into the candidate-to-job comparison feature data subset as a respective comparison feature comprises:
encoding the years difference value into a pre-defined data position for a years difference comparison feature in the candidate-to-job comparison feature data subset.

7. The computer system of claim 2, wherein encoding a candidate-to-job comparison feature data subset to include a difference value that corresponds with a pre-defined type of comparison feature that is learned as being predictive of whether a given job candidate is qualified for a given job posting comprises:
identifying each skill descriptor in a social network service profile of the target candidate account;
identifying each skill descriptor described in the job posting;
calculating a skill match value to represent a percentage of matching skill descriptors between the target candidate account's skill descriptors and each job posting's skill descriptors; and
inserting the skill match value into the candidate-to-job comparison feature data subset as a respective comparison feature.

8. The computer system of claim 6, wherein each skill descriptor in the social network service profile of the target candidate account comprises a respective skill descriptor selected by the target candidate account.

9. The computer system of claim 6, wherein each skill descriptor in the social network service profile of the target candidate account comprises a respective skill descriptor selected by a member account having a social network connection with the target candidate account.

10. The computer system of claim 6, wherein inserting the skill match value into the candidate-to-job comparison feature data subset as a respective comparison feature comprises:
encoding the skill match value into a pre-defined data position for a skill match comparison feature in the candidate-to-job comparison feature data subset.

11. The computer system of claim 1, wherein instantiating a plurality of job candidate decision trees, each job candidate decision tree comprising at least one learned decision tree branch label, comprises:
collecting, from within the social network service, logged interaction data comprising at least a first previous determination, by a first employer account, of a first candidate account as qualified for a first job posting and a second previous determination, by a second employer account, of a second candidate account as not qualified for a second job posting

12. The computer system of claim 11, wherein instantiating a plurality of job candidate decision trees, each job candidate decision tree comprising at least one learned decision tree branch label, further comprises:
executing a random forest process with the logged interaction data to build each job candidate decision tree.

13. The computer system of claim 12, wherein executing a random forest process with the logged interaction data to build each job candidate decision tree comprises:
learning a branch label for each branch of each job candidate decision tree
based on at least one attribute of the logged interaction data.

14. A computer-implemented method, comprising:
instantiating at least one data structure modeled according to a plurality of job candidate predictor decision trees, each job candidate predictor decision tree corresponding to a job candidate context feature type and comprising at least one learned decision tree branch label;
encoding data, via at least one processor, representing a job candidate context feature set based on at least one attribute of a target candidate account of a social network service and at least one attribute of a job posting on the social network service;
filtering at least one respective feature from the job candidate context feature set through a job candidate predictor decision tree that corresponds to a same job candidate context feature type as the respective feature; and
generating prediction output based on each result of filtering through the job candidate predictor decision trees, the prediction output indicating a likelihood of the target candidate account being qualified for the job posting.

15. The computer-implemented method of claim 14, wherein encoding data representing a job candidate context feature set based on at least one attribute of target candidate account of a social network service and at least one attribute of a job posting on the social network service comprises:
encoding a job candidate feature data subset to include the at least one attribute of the target candidate account that corresponds with at least one pre-defined type of candidate feature that is learned as being predictive of whether a given job candidate is qualified for a given job posting;
encoding a job feature data subset to include the at least one attribute of the job posting that corresponds with at least one pre-defined type of job feature that is learned as being predictive of whether the given job candidate is qualified for the given job posting; and
encoding a candidate-to-job comparison feature data subset to include a difference value between the at least one attribute of the target candidate account and the at least one attribute of the job posting that corresponds with a pre-defined type of comparison feature that is learned as being predictive of whether the given job candidate is qualified for the given job posting.

16. The computer-implemented method of claim 15, wherein encoding a candidate-to-job comparison feature data subset to include a difference value that corresponds with a pre-defined type of comparison feature that is learned as being predictive of whether a given job candidate is qualified for a given job posting comprises:
identifying years of candidate professional experience based on at least on employment time period descriptor in a social network service profile of the target candidate account;
identifying years of required professional experience described in the job posting;
calculating a years difference value to represent a difference between the years of candidate professional experience and the years of required professional experience; and
inserting the years difference value into the candidate-to-job comparison feature data subset as a respective comparison feature.

17. The computer-implemented method of claim 16, wherein inserting the years difference value into the candidate-to-job comparison feature data subset as a respective comparison feature comprises:
encoding the years difference value into a pre-defined data position for a years difference comparison feature in the candidate-to-job comparison feature data subset.

18. The computer-implemented method of claim 15, wherein encoding a candidate-to-job comparison feature data subset to include a difference value that corresponds with a pre-defined type of comparison feature that is learned as being predictive of whether a given job candidate is qualified for a given job posting comprises:
identifying each skill descriptor in a social network service profile of the target candidate account;
identifying each skill descriptor described in the job posting;
calculating a skill match value to represent a percentage of matching skill descriptors between the target candidate account's skill descriptors and each job posting's skill descriptors; and
inserting the skill match value into the candidate-to-job comparison feature data subset as a respective comparison feature.

19. The computer system of claim 18, wherein each skill descriptor in the social network service profile of the target candidate account comprises a respective skill descriptor selected by the target candidate account.

20. A non-transitory computer-readable medium storing executable instructions thereon, which, when executed by a processor, cause the processor to perform operations including:
instantiating at least one data structure modeled according to a plurality of job candidate predictor decision trees, each job candidate predictor decision tree corresponding to a job candidate context feature type and comprising at least one learned decision tree branch label;
encoding data representing a job candidate context feature set based on at least one attribute of a target candidate account of a social network service and at least one attribute of a job posting on the social network service;
filtering at least one respective feature from the job candidate context feature set through a job candidate predictor decision tree that corresponds to a same job candidate context feature type as the respective feature; and
generating prediction output based on each result of filtering through the job candidate predictor decision trees, the prediction output indicating a likelihood of the target candidate account being qualified for the job posting.
